(19) United States
(12) Patent Application Publication
(10) Pub. No.: US 2018/0304515 A1
(43) Pub. Date: Oct. 25, 2018

(54) SEALING DEVICE FOR CONTROLLING THE PRESSURE OR FLOW RATE IN A TUBE, AND METHOD FOR MANUFACTURING A TUBE

(71) Applicant: DYKA SAS, Sainte Austreberthe (FR)

(72) Inventor: Benoît DECAUDIN, Sempy (FR)

(73) Assignee: DYKA SAS, Sainte Austreberthe (FR)

(21) Appl. No.: 15/769,627

(22) PCT Filed: Oct. 10, 2016
(86) PCT No.: PCT/FR2016/052613

§ 371 Date: Apr. 19, 2018

(30) Foreign Application Priority Data
Oct. 19, 2015 (FR) 15/59933

(51) Int. Cl. B29C 47/08; B29C 47/00; B29C 49/00; B29C 49/04; B29C 55/24; B32B 1/08; B32B 5/04; B32B 5/08; B32B 5/10; B32B 5/12; B32B 5/26; B32B 7/00; B32B 27/12; B32B 27/32; B32B 27/34; B32B 27/36

(52) U.S. Cl. CPC B29C 47/0808; B32B 2597/00; B29C 47/0023; B29C 47/0057; B29C 49/0042; B29C 49/04; B29C 55/24; B32B 1/08; B32B 5/04; B32B 5/08; B32B 5/10; B32B 5/12; B32B 5/26; B32B 7/005; B32B 27/12; B32B 27/32; B32B 27/34; B32B 27/36; B32B 2262/0253; B32B 2262/0269; B32B 2262/14; B32B 2262/0276; B32B 2307/54; B32B 2307/72; B32B 2307/732; B29C 47/0042

(57) ABSTRACT

The sealing device (2) comprises a tubular sleeve (3) that can be radially deformed between a rest configuration and an inflated configuration; a fluid inlet fluidly fluidically connected to an inner chamber delimited by the tubular sleeve (3); an inner reinforcement casing (8) arranged around the tubular sleeve (3) and comprising a first inner reinforcement layer (9) consisting of reinforcement wires (10) wound helically around the tubular sleeve (3) in a first winding direction, and a second inner reinforcement layer (11) consisting of reinforcement wires (12) wound helically around the first inner reinforcement layer (9) in a second winding direction; and an outer reinforcement casing (21) arranged around the inner reinforcement casing (8), the outer reinforcement casing (21) comprising at least one outer reinforcement layer (22) consisting of reinforcement wires (23) extending parallel to the axis of extension (A) of the tubular sleeve (3).

### CROSS REFERENCE TO RELATED APPLICATIONS

This application is a National Stage of PCT Application No. PCT/FR2016/052613 filed on Oct. 10, 2016, which claims priority to French Patent Application No. 15/59933 filed on Oct. 19, 2015, the contents each of which are incorporated herein by reference thereto.

### TECHNICAL FIELD

The present invention concerns a sealing device for sealing or adjusting the pressure or the flow rate in a tube, and a method of manufacturing a tube made of plastic material using such a sealing device.

### BACKGROUND

The document EP0738379 describes a sealing device for adjusting the pressure or the flow rate in a tube, comprising:
an inflatable tubular sleeve having an axis of extension and delimiting an internal chamber, the inflatable tubular sleeve being flexible and deformable radially between a rest configuration wherein the inflatable tubular sleeve has a first maximum external diameter and an inflated configuration wherein the inflatable tubular sleeve has a second maximum external diameter greater than the first maximum external diameter,
a fluid inlet fluidly connected to the internal chamber and intended to be connected to an inflation fluid source, and
a reinforcement casing disposed around the inflatable tubular sleeve and extending coaxially with the inflatable tubular sleeve, the reinforcement casing comprising a first tubular reinforcing layer composed of reinforcing threads wound helically around the outer surface of the inflatable tubular sleeve in a first winding direction, and comprising a second tubular reinforcing layer composed of reinforcing threads wound helically around the first reinforcing layer according to a second winding direction reversed relative to the first winding direction.

Such a sealing device is more particularly intended to be used for manufacturing a biaxially oriented tube made of plastic material. A method for manufacturing a biaxially oriented tube made of plastic material, using such a sealing device, comprises in particular the steps consisting of:
extruding a tube made of plastic material,
displacing the extruded tube longitudinally in a direction of displacement,
disposing the sealing device and a sealing element inside the extruded tube and at a distance from each other so as to define an expansion area, the sealing device being disposed downstream of the sealing element relative to the direction of displacement of the extruded tube,
introducing an expansion fluid into the expansion area,
introducing an inflation fluid into the internal chamber of the sealing device so as to deform radially the inflatable tubular sleeve in its inflated configuration,
expanding diametrically the extruded tube using the expansion fluid retained at least partly in the expansion area, and

cooling the diametrically expanded tube.

During the manufacture of the biaxially oriented tube made of plastic material, the sealing device is subject to significant mechanical stresses resulting from the contact and the relative movement between the extruded tube and the sealing device. The presence of the reinforcement casing allows reinforcing the sealing device, and more particularly protecting the inflatable tubular sleeve and preventing a rapid breaking of the latter.

In addition, the helical configuration of the reinforcing threads of the reinforcement casing prevents an outward creep of the material constituting the tubular sleeve through the reinforcing threads, and thus avoids the formation of bulges through interstices between the reinforcing threads that could lead to the breaking of the tubular sleeve. Such a helical configuration thus allows to further extend the lifetime of the sealing device.

Nevertheless, such a sealing device has a lifetime of a few hours, which has a detrimental impact on the productivity of the manufacturing line, and therefore on the manufacturing costs of a biaxially oriented tube made of plastic material.

### BRIEF SUMMARY

The present invention aims to overcome these drawbacks.

The technical problem underlying the invention therefore consists in providing a sealing device having an extended lifetime.

For this purpose, the present invention concerns a sealing device for sealing or adjusting the pressure or the flow rate in a tube, comprising:
an inflatable tubular sleeve having an axis of extension and delimiting at least partially an internal chamber, the inflatable tubular sleeve being flexible and deformable radially between a rest configuration wherein the inflatable tubular sleeve has a first maximum external diameter and an inflated configuration wherein the inflatable tubular sleeve has a second maximum external diameter greater than the first maximum external diameter,
a fluid inlet fluidly connected to the internal chamber and intended to be connected to an inflation fluid source, the fluid inlet being configured to supply, in conditions of use, the internal chamber with inflation fluid so as to deform radially the inflatable tubular sleeve into its inflated configuration,
an internal reinforcement casing disposed around the inflatable tubular sleeve, the internal reinforcement casing comprising at least:
a first tubular internal reinforcing layer composed of reinforcing threads wound helically around the outer surface of the inflatable tubular sleeve and around the axis of extension of the inflatable tubular sleeve in a first winding direction, and
a second tubular internal reinforcing layer composed of reinforcing threads wound helically around the first internal reinforcing layer and around the axis of extension of the inflatable tubular sleeve in a second winding direction reversed relative to the first winding direction, and
an external reinforcement casing disposed around the internal reinforcement casing, the external reinforcement casing comprising at least one tubular external reinforcing layer composed of reinforcing threads,

at least one of the internal reinforcement casing and of the external reinforcement casing includes at least reinforcing threads made of a first material and reinforcing threads made of a second material different from the first material.

The presence of the external reinforcement casing allows increasing the mechanical tensile strength of the sealing device, and thus extending the lifetime of the sealing device.

In addition, surprisingly, the Applicant has noticed that the fact of composing the internal reinforcement casing and/or the external reinforcement casing from at least two different types of reinforcing threads allows adapting the mechanical properties of the internal reinforcement casing and/or the external reinforcement casing, on the one hand to further increase the mechanical strength of the sealing device and thus to further increase the lifetime of the sealing device, and on the other hand to improve the stability of the method for manufacturing the biaxially oriented tube, and thus the reliability of the manufactured tube.

Therefore, the sealing device according to the present invention allows improving the productivity of the manufacturing line, reducing the manufacturing costs of a biaxially oriented tube made of plastic material, and also increasing the reliability of such a tube.

The sealing device may further have one or more of the following features, considered alone or combined.

According to an embodiment of the invention, the internal reinforcement casing includes at least reinforcing threads made of a first material and reinforcing threads made of a second material different from the first material.

According to an embodiment of the invention, the internal reinforcement casing and the external reinforcement casing have different compositions of reinforcing threads. For example, the internal reinforcement casing is composed of reinforcing threads made of a first material and reinforcing threads made of a second material, and the external reinforcement casing is composed of reinforcing threads made of the first material and reinforcing threads made of the second material, the internal and external reinforcement casings having different proportions of reinforcing threads made of the first material and of the second material. Alternatively, the internal reinforcement casing could be composed of reinforcing threads made of a material different from the reinforcing threads composing the external reinforcement casing.

According to an embodiment of the invention, the internal reinforcement casing and the external reinforcement casing have identical compositions of reinforcing threads. For example, the internal reinforcement casing is composed of reinforcing threads made of a first material and of reinforcing threads made of a second material, and the external reinforcement casing is composed of reinforcing threads made of the first material and of reinforcing threads made of the second material, the internal and external reinforcement casings having substantially the same proportions of reinforcing threads made of the first material and of the second material, and for example each includes substantially 50% of reinforcing threads made of the first material and 50% of reinforcing threads made of the second material.

According to an embodiment of the invention, the external reinforcing layer is composed of reinforcing threads extending substantially parallel, and advantageously parallel to the axis of extension of the inflatable tubular sleeve. The particular configuration of the reinforcing threads belonging to the external reinforcement casing limits the increase in the radial rigidity of the sealing device resulting from the presence of the external reinforcement casing, which ensures a diametric deformation of the inflatable tubular sleeve without requiring the application of excessive pressure in the internal chamber and therefore without risk of rupturing the inflatable tubular sleeve. Such a configuration of the reinforcing threads thus allows to further extend the lifetime of the sealing device. Such a configuration of the reinforcing threads also allows to further improve the stability of the method for manufacturing the biaxially oriented tube.

According to an embodiment of the invention, the internal reinforcement casing extends substantially coaxially with the inflatable tubular sleeve.

According to an embodiment of the invention, the external reinforcement casing extends substantially coaxially with the inflatable tubular sleeve.

According to an embodiment of the invention, the internal reinforcement casing further comprises at least:
a third tubular internal reinforcing layer composed of reinforcing threads wound helically around the second internal reinforcing layer and around the axis of extension of the inflatable tubular sleeve in the first winding direction, and
a fourth tubular internal reinforcing layer composed of reinforcing threads wound helically around the third internal reinforcing layer and around the axis of extension of the inflatable tubular sleeve in the second winding direction.

According to an embodiment of the invention, the external reinforcement casing comprises a plurality of external reinforcing layers extending substantially coaxially relative to each other, for example two substantially coaxial external reinforcing layers.

According to an embodiment of the invention, each reinforcing thread belonging to the internal reinforcement casing extends at a helix angle comprised between 5 and 20° relative to the axis of extension of the inflatable tubular sleeve in the rest configuration.

According to an embodiment of the invention, the reinforcing threads belonging to the internal reinforcement casing extend at a substantially identical helix angle relative to the axis of extension of the inflatable tubular sleeve in the rest configuration.

According to an embodiment of the invention, each reinforcing thread belonging to the internal reinforcement casing has a modulus of elasticity greater than 125 g/d, and preferably greater than or equal to 500 g/d, and a maximum elongation at break less than or equal to 10%, preferably less than or equal to 5%. The modulus of elasticity and the maximum elongation at break are determined according to the standard ISO 2062.

According to an embodiment of the invention, the internal reinforcement casing is formed, at least partly, by reinforcing threads made of polybenzoxal, for example aramid, and/or reinforcing threads made of polytetrafluoroethylene (PTFE), for example Teflon (registered trademark), and/or reinforcing threads made of ultra-high molecular weight polyethylene, also called ultra-high molar mass polyethylene (UHMWPE or UHMwPE), and/or reinforcing threads made of liquid crystal polymer (LCP for Liquid Crystal Polymer), such as an aromatic polymer and in particular an aromatic polyester.

According to an embodiment of the invention, the internal reinforcement casing is formed by reinforcing threads made of UHMWPE, such as DYNEEMA (registered trademark) or SPECTRA (registered trademark), and/or reinforcing threads made of liquid crystal polymer, such as VECTRA (registered trademark) or VECTRAN (registered trademark).

According to an embodiment of the invention, the internal reinforcement casing is formed by a mixture of 10 to 90% of reinforcing threads made of UHMWPE, such as DYNEEMA, and of 90 to 10% of reinforcing threads made of liquid crystal polymer, such as VECTRAN, the percentage being expressed as the number of reinforcing threads relative to the total number of reinforcing threads forming the internal reinforcement casing. Such a composition of the internal reinforcement casing allows increasing the mechanical tensile strength of the internal reinforcement casing without impairing the diametric deformation of the inflatable tubular sleeve.

According to an embodiment of the invention, the internal reinforcement casing is formed by a mixture of 20 to 80%, advantageously of 40 to 60%, and for example about 50%, of reinforcing threads made of UHMWPE, and of 80 to 20%, advantageously of 60 to 40%, and for example of about 50%, of reinforcing threads made of liquid crystal polymer.

According to an embodiment of the invention, the sealing device further comprises an intermediate reinforcement casing disposed around the internal reinforcement casing and between the internal reinforcement casing and the external reinforcement casing, the intermediate reinforcement casing extending substantially coaxially with the inflatable tubular sleeve, the intermediate reinforcement casing comprising at least one tubular intermediate reinforcing layer composed of reinforcing threads extending substantially parallel to the axis of the extension of the inflatable tubular sleeve. The presence of the intermediate reinforcement casing allows, as the external reinforcement casing, to extend the lifetime of the sealing device.

According to an embodiment of the invention, the intermediate reinforcement casing comprises a plurality of intermediate reinforcing layers extending substantially coaxially relative to each other, and for example four intermediate reinforcing layers.

According to an embodiment of the invention, each reinforcing thread belonging to the intermediate reinforcement casing has a modulus of elasticity greater than 125 g/d and preferably greater than or equal to 500 g/d, and a maximum elongation at break less than or equal to 10%, preferably less than or equal to 5%.

According to an embodiment of the invention, the intermediate reinforcement casing is formed, at least partly, by reinforcing threads made of polybenzoxal, for example aramid, and/or reinforcing threads made of polytetrafluoroethylene (PTFE) for example Teflon (registered trademark), and/or reinforcing threads made of UHMWPE, and/or reinforcing threads made of liquid crystal polymer.

According to an embodiment of the invention, the intermediate reinforcement casing is formed by reinforcing threads made of UHMWPE and/or reinforcing threads made of liquid crystal polymer.

According to an embodiment of the invention, the intermediate reinforcement casing is formed by a mixture of 10 to 90% of reinforcing threads made of UHMWPE, such as DYNEEMA, and of 90 to 10% of reinforcing threads made of liquid crystal polymer, such as VECTRAN, the percentage being expressed as the number of reinforcing threads relative to the total number of reinforcing threads forming the intermediate reinforcement casing. Such a composition of the intermediate reinforcement casing allows increasing the mechanical tensile strength of the internal reinforcement casing, without impairing the diametric deformation of the inflatable tubular sleeve.

According to an embodiment of the invention, the intermediate reinforcement casing is formed by a mixture of 20 to 80%, advantageously of 40 to 60%, and for example of about 50% of reinforcing threads made of UHMWPE, and of 80 to 20%, advantageously of 60 to 40%, and for example of about 50%, of reinforcing threads made of liquid crystal polymer.

According to an embodiment of the invention, each reinforcing thread belonging to the external reinforcement casing has a modulus of elasticity greater than 125 g/d and preferably greater than or equal to 500 g/d, and a maximum elongation at break less than or equal to 10%, preferably less than or equal to 5%.

According to an embodiment of the invention, the external reinforcement casing is formed, at least partly, by reinforcing threads made of UHMWPE, and/or reinforcing threads made of liquid crystal polymer, and/or reinforcing threads made of polybenzoxal, and/or reinforcing threads made of polytetrafluoroethylene.

According to an embodiment of the invention, the reinforcing threads belonging to the external reinforcement casing are made of UHMWPE. Such a composition of the external reinforcement casing allows limiting, during the manufacture of a biaxially oriented tube, the friction between the tube and the sealing device due to the high sliding coefficient of the UHMWPE. These arrangements thus allow improving the stability of the method for manufacturing the biaxially oriented tube, and therefore the reliability of the manufactured tube. In addition, the use of the UHMWPE for making the external reinforcement casing allows limiting the increase in the radial rigidity of the sealing device related to the presence of the external reinforcement casing.

According to an embodiment of the invention, the reinforcing threads belonging to the external reinforcement casing are made of DYNEEMA.

According to an embodiment of the invention, each reinforcing thread made of liquid crystal polymer belonging to the internal reinforcement casing and/or to the intermediate reinforcement casing has a linear density comprised between 25 and 3750 Denier, that is to say between 25 and 3750 g/9000 m. For example, each reinforcing thread made of liquid crystal polymer belonging to the internal reinforcement casing and/or to the intermediate reinforcement casing has a linear density comprised between 1000 and 2000 Denier, and advantageously between 1400 and 1600 Denier, that is to say between 1000 and 2000 g/9000 m, and advantageously between 1400 and 1600 g/9000 m.

According to an embodiment of the invention, each reinforcing thread made of liquid crystal polymer belonging to the internal reinforcement casing and/or to the intermediate reinforcement casing has a linear density comprised between 27 and 4160 Decitex, that is to say between 27 and 4160 g/10000 m.

According to an embodiment of the invention, each reinforcing thread made of liquid crystal polymer belonging to the internal reinforcement casing and/or to the intermediate reinforcement casing has a modulus of elasticity greater than 525 g/d (grams per denier), and for example greater than 600 g/d.

According to an embodiment of the invention, each reinforcing thread made of liquid crystal polymer belonging to the internal reinforcement casing and/or to the intermediate reinforcement casing has a maximum elongation at break comprised between 2 and 3.3%.

According to an embodiment of the invention, each reinforcing thread made of UHMWPE belonging to the internal reinforcement casing, and/or to the intermediate reinforcement casing and/or to the external reinforcement casing has a linear density comprised between 130 and 4800 Denier, that is to say between 130 and 4800 g/9000 m.

According to an embodiment of the invention, each reinforcing thread made of UHMWPE belonging to the internal reinforcement casing, and/or to the intermediate reinforcement casing and/or to the external reinforcement casing has a linear density comprised between 144 and 5300 Decitex, that is to say between 144 and 5300 10⁻⁷ Kg/m or g/10000 m. For example, each reinforcing thread made of UHMWPE belonging to the internal reinforcement casing, and/or to the intermediate reinforcement casing and/or to the external reinforcement casing has a linear density comprised between 1100 and 2640 Decitex, and advantageously between 1500 and 1800 Decitex, that is to say between 1100 and 2640 10⁻⁷ kg/m or g/10000 m and advantageously between 1500 and 1800 10⁻⁷ Kg/m or g/10000 m.

According to an embodiment of the invention, each reinforcing thread made of UHMWPE belonging to the internal reinforcement casing, and/or to the intermediate reinforcement casing and/or to the external reinforcement casing has a linear density of about 1760 Decitex, that is to say between 1760 10⁻⁷ Kg/m or g/10000 m, and is for example of 1760 dtex DYNEEMA.

According to an embodiment of the invention, each reinforcing thread made of UHMWPE belonging to the internal reinforcement casing, and/or to the intermediate reinforcement casing and/or to the external reinforcement casing has a modulus of elasticity greater than 720 g/d (grams per denier), and for example greater than 1350 g/d.

According to an embodiment of the invention, each reinforcing thread made of UHMWPE belonging to the internal reinforcement casing, and/or to the intermediate reinforcement casing and/or to the external reinforcement casing has a maximum elongation at break comprised between 2.7 and 3.5%.

According to an embodiment of the invention, the fluid inlet is intended to be fluidly connected to a supply duct connected to the inflation fluid source.

According to an embodiment of the invention, the sealing device further comprises a first and a second support elements on which are tightly fastened respectively a first and a second end portions of the inflatable tubular sleeve.

According to an embodiment of the invention, each reinforcing thread belonging to the internal, intermediate and external reinforcement casings connects the first and second support elements.

According to an embodiment of the invention, the inflatable tubular sleeve is made of waterproof material.

According to an embodiment of the invention, the inflatable tubular sleeve has a circular section.

According to an embodiment of the invention, the internal reinforcement casing, and/or the intermediate reinforcement casing and/or the external reinforcement casing extends over substantially the entire length of the inflatable tubular sleeve.

The present invention further concerns a sealing device for sealing or adjusting the pressure or the flow rate in a tube, comprising:
an inflatable tubular sleeve having an axis of extension and delimiting at least partially an internal chamber, the inflatable tubular sleeve being flexible and deformable radially between a rest configuration wherein the inflatable tubular sleeve has a first maximum external diameter and an inflated configuration wherein the inflatable tubular sleeve has a second maximum external diameter greater than the first maximum external diameter,
a fluid inlet fluidly connected to the internal chamber and intended to be connected to an inflation fluid source, the fluid inlet being configured to supply, in conditions of use, the internal chamber with inflation fluid so as to deform radially the inflatable tubular sleeve into its inflated configuration,
an internal reinforcement casing disposed around the inflatable tubular sleeve, the internal reinforcement casing comprising at least:
a first tubular internal reinforcing layer composed of reinforcing threads wound helically around the outer surface of the inflatable tubular sleeve and around the axis of extension of the inflatable tubular sleeve in a first winding direction, and
a second tubular internal reinforcing layer composed of reinforcing threads wound helically around the first internal reinforcing layer and around the axis of extension of the inflatable tubular sleeve in a second winding direction reversed relative to the first winding direction, and
an external reinforcement casing disposed around the internal reinforcement casing, the external reinforcement casing comprising at least one tubular external reinforcing layer composed of reinforcing threads,

the internal reinforcement casing and the external reinforcement casing having different compositions of reinforcing threads.

Such a sealing device may further have one or more previously described feature(s), considered alone or in combination. For example, the internal reinforcement casing may be composed of reinforcing threads made of a first material and reinforcing threads made of a second material, and the external reinforcement casing may be composed of reinforcing threads made of the first material and reinforcing threads made of the second material, the internal and external reinforcement casings having different proportions of reinforcing threads made of the first material and of the second material. Alternatively, the internal reinforcement casing may be composed of reinforcing threads made of a first material and the internal reinforcement casing may be composed of reinforcing threads made of a second material different from the first material.

The present invention further concerns a method for manufacturing a tube made of plastic material, and for example a biaxially oriented tube made of plastic material, comprising the steps consisting of:
extruding a tube made of plastic material,
displacing the extruded tube longitudinally in a direction of displacement,
disposing a sealing device according to the invention and a sealing element inside the extruded tube and at a distance from each other so as to define an expansion area, the sealing device being disposed downstream of the sealing element relative to the direction of displacement of the extruded tube,
introducing an expansion fluid into the expansion area,
introducing an inflation fluid into the internal chamber of the sealing device so as to deform radially the inflatable tubular sleeve in its inflated configuration,
expanding diametrically the extruded tube using the expansion fluid retained at least partly in the expansion area, and
cooling the diametrically expanded tube.

Such a manufacturing method, and in particular the use of a sealing device according to the invention for manufacturing a biaxially oriented tube made of plastic material, allows reducing the number of stops in the manufacturing line related to the replacements of the sealing device, and also reducing the loss of material. This results in a significant decrease in the manufacturing costs of the tube.

According to a mode of implementation of the manufacturing method, the latter further comprises a step consisting in drawing axially the extruded tube, the drawing step being performed before or after the expansion step.

According to a mode of implementation of the manufacturing method, the latter further comprises a step consisting in maintaining the pressure in the expansion area in a predetermined pressure range.

The present invention also concerns using a sealing device according to the invention for manufacturing a tube made of plastic material, for example a biaxially oriented tube made of plastic material.

### BRIEF DESCRIPTION OF THE DRAWINGS

In any case, the invention will be better understood using the following description with reference to the appended schematic drawing showing, by way of non-restrictive example, an embodiment of this sealing device.

FIG. 1 is a schematic side view of a sealing device according to the present invention, in a rest configuration.

FIG. 2 is a schematic side view of the sealing device of FIG. 1, in an inflated configuration.

FIG. 3 is a partial sectional view of the sealing device of FIG. 1.

FIG. 4 is a schematic perspective view of the sealing device of FIG. 1, showing the different reinforcing layers constituting the internal, intermediate and external reinforcement casings of the sealing device.

FIG. 5 is a schematic view of a manufacturing line of a biaxially oriented tube made of plastic material.

### DETAILED DESCRIPTION

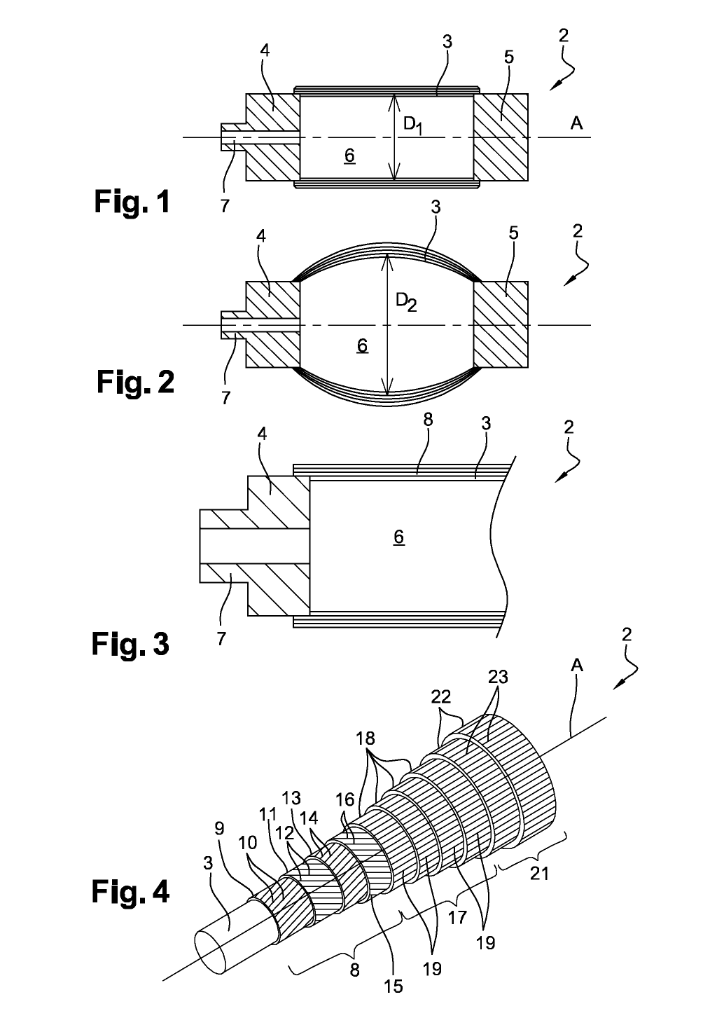

FIGS. 1 to 4 show a sealing device 2 configured to seal or to adjust the pressure or the flow rate in a tube.

The sealing device 2 comprises an inflatable tubular sleeve 3 having an axis of extension A. The inflatable tubular sleeve 3 is made of a waterproof material, for example elastomer, and advantageously has a globally circular section.

The inflatable tubular sleeve 3 is flexible and is deformable radially between a rest configuration (see FIG. 1) wherein the inflatable tubular sleeve 3 has a first maximum external diameter D1, and an inflated configuration (see FIG. 2) wherein the inflatable tubular sleeve 3 has a second maximum external diameter D2 greater than the first maximum external diameter D1.

The sealing device 2 also comprises a first support element 4 and a second support element 5 on which are tightly fastened respectively a first and a second end portions of the inflatable tubular sleeve 3. The inflatable tubular sleeve 3 and the first and second support elements 4, 5 delimit an internal chamber 6.

The sealing device 2 further comprises a fluid inlet 7 provided on the first support element 4. The fluid inlet 7 opens into the internal chamber 6, and is intended to be connected to a supply duct connected to an inflation fluid source. The fluid inlet 7 is more particularly configured to supply, in conditions of use, the internal chamber 6 with inflation fluid so as to deform radially the inflatable tubular sleeve 3 into its inflated configuration.

The sealing device 2 further comprises an internal reinforcement casing 8 disposed around the inflatable tubular sleeve 3 and extending coaxially with the inflatable tubular sleeve 3. The internal reinforcement casing 8 includes a first end portion fastened on the first support element 4, and a second end portion fastened on the second support element 5.

According to the embodiment shown in the figures, the internal reinforcement casing 8 comprises:
a first tubular internal reinforcing layer 9 composed of reinforcing threads 10 wound helically around the outer surface of the inflatable tubular sleeve 3 and around the axis of extension A of the inflatable tubular sleeve in a first winding direction,
a second tubular internal reinforcing layer 11 composed of reinforcing threads 12 wound helically around the first internal reinforcing layer 9 and around the axis of extension A of the inflatable tubular sleeve 3 in a second winding direction reversed relative to the first winding direction,
a third tubular internal reinforcing layer 13 composed of reinforcing threads 14 wound helically around the second internal reinforcing layer 11 and around the axis of extension A of the inflatable tubular sleeve 3 in the first winding direction, and
a fourth tubular internal reinforcing layer 15 composed of reinforcing threads 16 wound helically around the third internal reinforcing layer 13 and around the axis of extension A of the inflatable tubular sleeve 3 in the second winding direction.

According to a variant of the invention, the internal reinforcement casing 8 could, however, comprise only the first and second reinforcing layers 9, 11.

Each reinforcing thread 10, 12, 14, 16 belonging to the internal reinforcement casing 8 advantageously comprises a first end fastened on the first support element 4, and a second end fastened on the second support element 5. For this purpose, each of the first and second support elements 4, 5 may be provided for example with a plurality of anchoring elements on which can be fastened the first and second ends of the reinforcing threads 10, 12, 14, 16.

According to an embodiment of the invention, each reinforcing thread 10, 12, 14, 16 belonging to the internal reinforcement casing 8 extends at a helix angle comprised between 5 and 20°, and preferably less than 15°, relative to the axis of extension A of the inflatable tubular sleeve 3 in the rest configuration. The reinforcing threads 10, 12, 14, 16 belonging to the internal reinforcement casing 8 advantageously extend at a substantially identical helix angle. Nevertheless, the reinforcing threads 10, 12, 14, 16 belonging to the internal reinforcement casing 8 could also extend at different helix angles.

According to an embodiment of the invention, each reinforcing thread 10, 12, 14, 16 belonging to the internal reinforcement casing 8 extends over less than one turn of a helix, that is to say over one turn portion.

The internal reinforcement casing 8 may be formed by reinforcing threads made of UHMWPE, by reinforcing threads made of liquid crystal polymer or by a mixture of reinforcing threads made of UHMWPE and reinforcing threads made of liquid crystal polymer. The internal reinforcement casing 8 may for example be formed by a mixture:
of 10 to 90%, advantageously of 20 to 80%, preferably of 40 to 60%, and for example of about 50%, of reinforcing threads made of UHMWPE, and
of 90 to 10%, preferably of 80 to 20%, advantageously of 60 to 40%, and for example of about 50%, of reinforcing threads made of liquid crystal polymer, the percentage being expressed as the number of reinforcing threads relative to the total number of reinforcing threads forming the internal reinforcement casing 8.

Advantageously, each of the first, second, third and fourth internal reinforcing layers 9, 11, 13, 15 is formed by a mixture:
of 10 to 90%, advantageously of 20 to 80%, preferably of 40 to 60%, and for example of about 50% of reinforcing threads made of UHMWPE, and
of 90 to 10%, preferably of 80 to 20%, advantageously of 60 to 40%, and for example of about 50% of reinforcing threads made of liquid crystal polymer, the percentage being expressed as the number of reinforcing threads relative to the total number of reinforcing threads forming said internal reinforcing layer.

The sealing device 2 further comprises an intermediate reinforcement casing 17 disposed around the internal reinforcement casing 8, and extending coaxially with the inflatable tubular sleeve 3. The intermediate reinforcement casing 17 includes a first end portion fastened on the first support element 4, and a second end portion fastened on the second support element 5.

According to the embodiment shown in the figures, the intermediate reinforcement casing 17 comprises a plurality of coaxial tubular intermediate reinforcing layers 18, and for example four intermediate reinforcing layers 18. Each intermediate reinforcing layer 18 is composed of reinforcing threads 19 extending parallel to the axis of extension A of the inflatable tubular sleeve 3.

According to a variant of the invention, the intermediate reinforcement casing 17 could, however, comprise only one intermediate reinforcing layer 18, two, three or more than four intermediate reinforcing layers 18.

Each reinforcing thread 19 belonging to the intermediate reinforcement casing 17 advantageously comprises a first end fastened on the first support element 4, and a second end fastened on the second support element 5.

The intermediate reinforcement casing 17 may be formed by reinforcing threads 19 made of UHMWPE, by reinforcing threads 19 made of liquid crystal polymer, or by a mixture of reinforcing threads 19 made of UHMWPE and reinforcing threads 19 made of liquid crystal polymer. The intermediate reinforcement casing 17 may for example be formed by a mixture:
of 10 to 90%, advantageously of 20 to 80%, preferably of 40 to 60%, and for example of about 50%, of reinforcing threads made of UHMWPE, and
of 90 to 10%, preferably of 80 to 20%, advantageously of 60 to 40%, and for example of about 50%, of reinforcing threads made of liquid crystal polymer, the percentage being expressed as the number of reinforcing threads relative to the total number of reinforcing threads forming the intermediate reinforcement casing 17.

Advantageously, each intermediate reinforcing layer 18 is formed by a mixture:
of 10 to 90%, advantageously of 20 to 80%, preferably of 40 to 60%, and for example of about 50%, of reinforcing threads made of UHMWPE, and
of 90 to 10%, preferably of 80 to 20%, advantageously of 60 to 40%, and for example of about 50%, of reinforcing threads made of liquid crystal polymer, the percentage being expressed as the number of reinforcing threads relative to the total number of reinforcing threads forming said intermediate reinforcing layer.

The sealing device 2 further comprises an external reinforcement casing 21 disposed around the intermediate reinforcement casing 17 and extending coaxially with the inflatable tubular sleeve 3. The external reinforcement casing 21 includes a first end portion fastened on the first support element 4, and a second end portion fastened on the second support element 5.

According to the embodiment shown in the figures, the external reinforcement casing 21 comprises a plurality of coaxial tubular external reinforcing layers 22, and for example two external reinforcing layers 22. Each external reinforcing layer 22 is composed of reinforcing threads 23 extending parallel to the axis of extension A of the inflatable tubular sleeve 3. Advantageously, the reinforcing threads 23 belonging to the external reinforcement casing 21 are made of UHMWPE.

According to a variant of the invention, the external reinforcement casing 21 could however comprise only one external reinforcing layer 22, or more than two external reinforcing layers 22.

Each reinforcing thread 23 belonging to the external reinforcement casing 21 advantageously comprises a first end fastened on the first support element 4, and a second end fastened on the second support element 5.

According to an embodiment of the invention, each reinforcing thread made of liquid crystal polymer belonging to the internal reinforcement casing 8, and to the intermediate reinforcement casing 17 has:
a linear density comprised between 25 and 3750 Denier, that is to say between 25 and 3750 g/9000 m;
a linear density comprised between 27 and 4160 Decitex, that is to say between 27 and 4160 g/10000 m;
a modulus of elasticity greater than 525 g/d (grams per denier), and for example greater than 600 g/d; and
a maximum elongation at break less than or equal to 10%, preferably less than or equal to 5%, and for example comprised between 2 and 3.3%.

According to an embodiment of the invention, each reinforcing thread made of UHMWPE belonging to the internal reinforcement casing 8, to the intermediate reinforcement casing 17 and to the external reinforcement casing 21 has:
a linear density comprised between 130 and 4800 Denier, that is to say between 130 and 4800 g/9000 m;
a linear density comprised between 144 and 5300 Decitex, that is to say between 144 and 5300 10⁻⁷ Kg/m or g/10000 m;
a modulus of elasticity greater than 720 g/d (grams per denier), and for example greater than 1350 g/d; and
a maximum elongation at break less than or equal to 10%, preferably less than or equal to 5%, for example comprised between 2.7 and 3.5%.

According to a preferred embodiment of the invention, the sealing device 2 includes:
an internal reinforcement casing 8 including four internal reinforcing layers 9, 11, 13, 15 each formed by a mixture of 50% of reinforcing threads made of 1760 dtex DYNEEMA, and of 50% of reinforcing threads made of 1500 Denier VECTRAN, the percentage being expressed as the number of reinforcing threads relative to the total number of reinforcing threads forming said internal reinforcing layer 8,
an intermediate reinforcement casing 17 including four intermediate reinforcing layers 18 each formed by a mixture of 50% of reinforcing threads made of 1760 dtex DYNEEMA, and 50% of reinforcing threads made of 1500 denier VECTRAN, the percentage being expressed as the number of reinforcing threads relative to the total number of reinforcing threads forming said intermediate reinforcing layer 17, and
an external reinforcement casing 21 including two external reinforcing layers 22 each formed by reinforcing threads 23 made of 1760 dtex DYNEEMA.

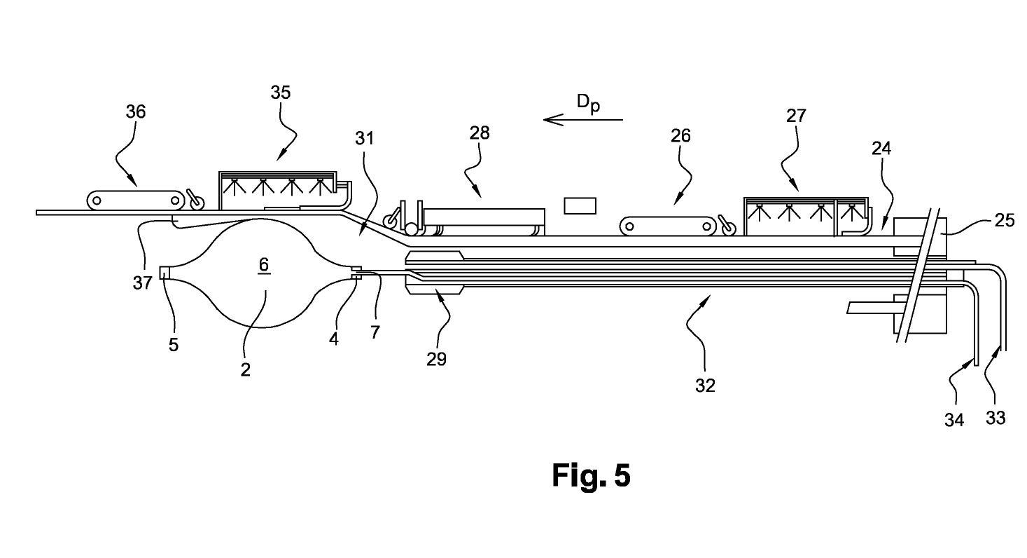

A method for manufacturing a biaxially oriented tube made of plastic using the sealing device 2 will now be described with reference to FIG. 5. Such a method comprises the following steps consisting of:
extruding a tube 24 made of plastic material with an extruder 25 provided with a sizing die,
displacing the extruded tube 24 longitudinally in a direction of displacement Dp using a first drawing device 26,
cooling the extruded tube 24 using a first cooling device 27,
temperature-conditioning the extruded tube 24 with a temperature conditioning device 28,
disposing the sealing device 2 and a sealing element 29 inside the extruded tube 24 and at a distance from each other so as to define an expansion area 31, the sealing device 2 being disposed downstream of the sealing element 29 relative to the direction of displacement Dp of the extruded tube 24, the sealing device 2 and the sealing element 29 being maintained in position by means of a service tube 32 connected to a retainer device (not shown in the figures),
introducing an expansion fluid into the expansion area 31 via a supply duct 33 connected to an expansion fluid source (not shown in the figures) and extending partly into the service tube 32,
introducing an inflation fluid into the internal chamber 6 of the sealing device 2 via a supply duct 34 connected on the one hand to the fluid inlet 7 and on the other hand to an inflation fluid source (not shown in the figures), so as to deform radially the inflatable tubular sleeve 3 in its inflated configuration,
expanding diametrically the extruded tube 24 using the expansion fluid retained at least partly in the expansion area 31, and
cooling the diametrically expanded tube using a second cooling device 35.

The manufacturing method further comprises a step consisting in drawing axially the extruded tube 24, such a step being performed before or after the expansion step. Such an axial drawing step may be carried out using a second drawing device 36 disposed downstream of the expansion area 31 and having a speed at least equal to or greater than that of the first drawing device 26.

According to a mode of implementation of the manufacturing method, the latter further comprises a step consisting in maintaining the pressure in the expansion area 31 in a predetermined pressure range. Such a maintenance of pressure is advantageously made by ensuring a leakage flow rate 37 between the extruded tube 24 and the sealing device 2.

As it goes without saying, the invention is not restricted to the sole embodiment of this sealing device 2, described hereinabove by way of example, it encompasses on the contrary all the variants.

1. A sealing device for sealing or adjusting the pressure or the flow rate in a tube, comprising:
an inflatable tubular sleeve having an axis of extension (A) and delimiting at least partially an internal chamber, the inflatable tubular sleeve being flexible and deformable radially between a rest configuration wherein the inflatable tubular sleeve has a first maximum external diameter (D1) and an inflated configuration wherein the inflated tubular sleeve has a second maximum external diameter (D2) greater than the first maximum external diameter (D1),
a fluid inlet fluidly connected to the internal chamber and intended to be connected to an inflation fluid source, the fluid inlet being configured to supply, in use, the internal chamber with inflation fluid so as to deform radially the inflatable tubular sleeve in its inflated configuration,
an internal reinforcement casing disposed around the inflatable tubular sleeve, the internal reinforcement casing comprising at least:
a first internal reinforcing layer which is tubular and composed of reinforcing threads (10) wound helically around the outer surface of the inflatable tubular sleeve and around the axis of extension (A) of the inflatable tubular sleeve in a first winding direction, and
a second internal reinforcing layer which is tubular and composed of reinforcing threads wound helically around the first internal reinforcing layer and around the axis of extension (A) of the inflatable tubular sleeve in a second winding direction reversed relative to the first winding direction, and
an external reinforcement casing disposed around the internal reinforcement casing, the external reinforcement casing comprising at least one external reinforcing layer which is tubular and composed of reinforcing threads,
at least one of the internal reinforcement casing and of the external reinforcement casing include at least reinforcing threads made of a first material and reinforcing threads made of a second material different from the first material.

2. The sealing device according to claim 1, wherein the external reinforcing layer is composed of reinforcing threads extending substantially parallel to the axis of extension (A) of the inflatable tubular sleeve.

3. The sealing device according to claim 1, wherein the internal reinforcement casing further comprises at least:
a third internal reinforcing layer which is tubular and composed of reinforcing threads wound helically around the second internal reinforcing layer and around the axis of extension (A) of the inflatable tubular sleeve in the first winding direction, and
a fourth internal reinforcing layer which is tubular and composed of reinforcing threads wound helically around the third internal reinforcing layer and around the axis of extension (A) of the inflatable tubular sleeve in the second winding direction.

4. The sealing device according to claim 1, wherein the external reinforcement casing comprises a plurality of external reinforcing layers extending substantially coaxially with each other.

5. The sealing device according to claim 1, wherein each reinforcing thread belonging to the internal reinforcement casing extends at a helix angle comprised between 5 and 20° relative to the axis of extension (A) of the inflatable tubular sleeve into the rest configuration.

6. The sealing device according to claim 1, wherein the reinforcing threads belonging to the internal reinforcement casing extend at a substantially identical helix angle relative to the axis of extension (A) of the inflatable tubular sleeve into the rest configuration.

7. The sealing device according to claim 1, wherein each reinforcing thread belonging to the internal reinforcement casing has a modulus of elasticity greater than 125 g/d, and preferably greater than or equal to 500 g/d, and a maximum elongation at break less than or equal to 10%, preferably less than or equal to 5%.

8. The sealing device according to claim 1, wherein the internal reinforcement casing is formed, at least partly, by reinforcing threads made of UHMWPE, and/or reinforcing threads made of liquid crystal polymer, and/or reinforcing threads made of polybenzoxal, and/or reinforcing threads made of polytetrafluoroethylene.

9. The sealing device according to claim 1, wherein the internal reinforcement casing is formed by reinforcing threads made of UHMWPE and/or reinforcing threads made of liquid crystal polymer.

10. The sealing device according to claim 1, wherein the internal reinforcement casing is formed by a mixture of 10 to 90% of reinforcing threads made of UHMWPE, and of 90 to 10% of reinforcing threads made of liquid crystal polymer, the percentage being expressed as the number of reinforcing threads relative to the total number of reinforcing threads forming the internal reinforcement casing.

11. The sealing device according to claim 1, which further comprises an intermediate reinforcement casing disposed around the internal reinforcement casing and between the internal reinforcement casing and the external reinforcement casing, the intermediate reinforcement casing extending substantially coaxially with the inflatable tubular sleeve, the intermediate reinforcement casing comprising at least one intermediate reinforcing layer which is tubular and composed of reinforcing threads extending substantially parallel to the axis of extension (A) of the inflatable tubular sleeve.

12. The sealing device according to claim 11, wherein the intermediate reinforcement casing comprises a plurality of intermediate reinforcing layers extending substantially coaxially relative to each another.

13. The sealing device according to claim 11, wherein each reinforcing thread belonging to the intermediate reinforcement casing has a modulus of elasticity greater than 125 g/d, and preferably greater than or equal to 500 g/d, and a maximum elongation at break less than or equal to 10%, preferably less than or equal to 5%.

14. The sealing device according to claim 11, wherein the intermediate reinforcement casing is formed at least partly, by reinforcing threads made of UHMWPE, and/or reinforcing threads made of liquid crystal polymer, and/or reinforcing threads made of polybenzoxal, and/or reinforcing threads made of polytetrafluoroethylene.

15. The sealing device according to claim 11, wherein the intermediate reinforcement casing is formed by reinforcing threads made of UHMWPE and/or reinforcing threads made of liquid crystal polymer.

16. The sealing device according to claim 11, wherein the intermediate reinforcement casing is formed by a mixture of 10 to 90% of reinforcing threads made of UHMWPE, and of 90% to 10% of reinforcing threads made of liquid crystal polymer, the percentage being expressed as the number of reinforcing threads relative to the total number of reinforcing threads forming the intermediate reinforcement casing.

17. The sealing device according to claim 1, wherein each reinforcing thread belonging to the external reinforcement casing has a modulus of elasticity greater than 125 g/d, and preferably greater than or equal to 500 g/d, and a maximum elongation at break less than or equal to 10%, preferably less than or equal to 5%.

18. The sealing device according to claim 1, wherein the external reinforcement casing is formed, at least partly, by reinforcing threads made of UHMWPE, and/or reinforcing threads made of liquid crystal polymer, and/or reinforcing threads made of polybenzoxal, and/or reinforcing threads made of polytetrafluoroethylene.

19. The sealing device according to claim 1, wherein the reinforcing threads belonging to the external reinforcement casing are made of UHMWPE.

20. The sealing device according to claim 1, which further comprises a first and a second support elements on which are tightly fastened respectively a first and a second end portions of the inflatable tubular sleeve.

21. A method for manufacturing a tube made of plastic material, comprising the steps consisting in:
extruding a tube made of plastic material,
displacing the extruded tube longitudinally in a direction of displacement (Dp),
disposing a sealing device according to claim 1 and a sealing element inside the extruded tube and at a distance from each other so as to define an expansion area, the sealing device being disposed downstream of the sealing element relative to the direction of displacement (Dp) of the extruded tube,
introducing an expansion fluid into the expansion area,
introducing an inflation fluid into the internal chamber of the sealing device so as to deform radially the inflatable tubular sleeve in its inflated configuration,
expanding diametrically the extruded tube using the expansion fluid retained at least partly in the expansion area, and
cooling the diametrically expanded tube.

22. The manufacturing method according to claim 21, which further comprises a step consisting in drawing axially the extruded tube.

23. The manufacturing method according to claim 21, which further comprises a step consisting in maintaining the pressure in the expansion area in a predetermined pressure range.

24. (canceled)
